(19) United States
(12) Patent Application Publication
(10) Pub. No.: US 2008/0063854 A1
(43) Pub. Date: Mar. 13, 2008

(54) Multilayer foaming lamination

(75) Inventors: Chung-Hu Hsiao, Taichung City (TW); Chien-Hua Yeh, Changhua County (TW)

Correspondence Address: BROWDY AND NEIMARK, P.L.L.C.;624 NINTH STREET, NW, SUITE 300, WASHINGTON, DC, 20001-5303, US

(73) Assignee: Tiong Liong Industrial Co., Ltd., Taichung Hsien (TW)

(21) Appl. No.: 11/544,868

(22) Filed: Oct. 10, 2006

(30) Foreign Application Priority Data
Sep. 13, 2006 (TW) 95133949

(51) Int. Cl. B32B 3/26

(52) U.S. Cl. 428/304.4

(57) ABSTRACT

A multilayer foaming lamination includes a foaming layer and two skin layers provided on opposite sides of the foaming layer. The foaming layer includes a first material with apertures and second materials filled in the apertures respectively. The first material and the second material are made of different materials or are made of the same material but having different foaming conditions.

### BACKGROUND OF THE INVENTION

1. Field of the Invention

The present invention relates to a foaming material, and more particularly to a multilayer foaming lamination.

2. Description of the Related Art

Typically, a conventional foaming lamination includes a foaming layer 1 and two skin layers 2 on opposite sides of the foaming layer 1 as shown in FIG. 1. This kind of foaming lamination provides the buffering and vibration absorbing function. However, the conventional foaming laminations only provides single foaming layer, which is the main providing the buffering function, and the buffering function is limited in the material capacity of the foaming layer that makes the conventional foaming laminations only applied in specific field.

### SUMMARY OF THE INVENTION

The object of the present invention is to provide a multilayer foaming lamination, which provides various and changeable capacities.

To achieve this object of the present invention, a multilayer foaming lamination includes a foaming layer and two skin layers provided on opposite sides of the foaming layer. The foaming layer includes a first material with apertures and second materials filled in the apertures respectively. The first material and the second material are made of different materials or are made of the same material but having different foaming conditions.

### BRIEF DESCRIPTION OF THE DRAWINGS

FIG. 1 is a sectional view of the conventional foaming lamination;

FIG. 2 is a sectional view of a first preferred embodiment of the present invention;

FIG. 3 is a sectional view of a second preferred embodiment of the present invention; and

FIG. 4 is a sectional view of a third preferred embodiment of the present invention.

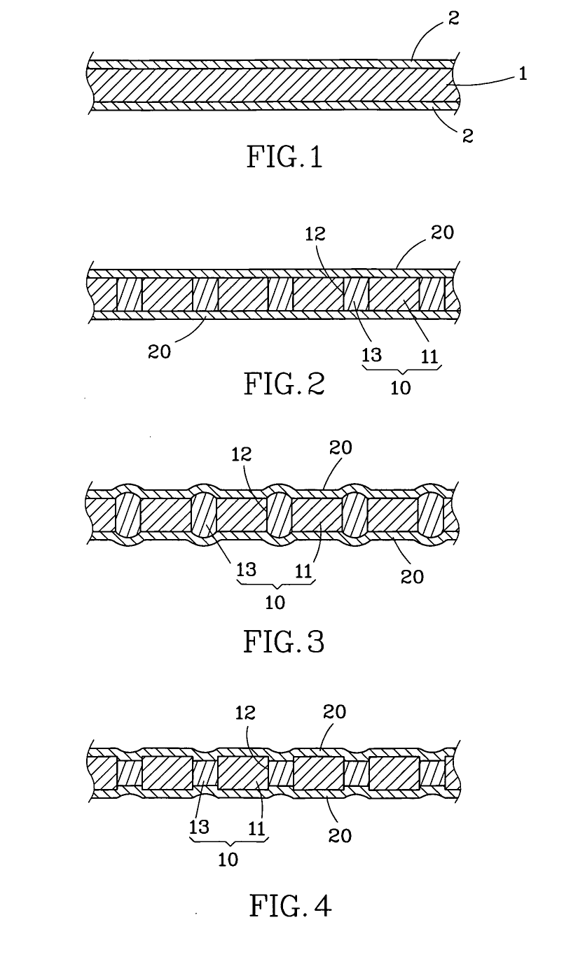

### DETAILED DESCRIPTION OF THE INVENTION

Referring to FIG. 2, a multilayer foaming lamination of the first preferred embodiment of the present invention includes:

A foaming layer 10, which consists of two or more layers made of different materials or made of the same material but with different foaming conditions, includes a first material 11 with apertures 12 through the first material 11 and second materials 13 filled in the apertures 12. A thickness of the first material 11 is as same as that of the second materials 13. The first and second materials 11, 13 may have plenty of choices, such as the first material 11 is made of polyurethane (PU) or thermoplastic urethane (TPU) foaming material and the second material 13 is a foaming material added with carbon or nano carbon or far infrared rays mineral, or the first material 11 is made of a softer material and the second material 13 is made of a harder material, or the colors of the first and second materials 11, 13 are different.

Two skin layers 20, which may be made of cotton, flax, nylon or polymer weaved fabric, nonweaved fabric or gauze, are laminated on opposite sides of the foaming layer 10.

The first preferred embodiment provides the multilayer foaming lamination with different material properties or different colors that enlarges the applying range of the foaming lamination.

FIG. 2 shows a multilayer foaming lamination of the second preferred embodiment of the present invention, which is similar to the first preferred embodiment, including a foaming layer 10 and two skin layers 20. The foaming layer 10 includes a first material 11 with apertures 12 and second materials 13 filled in the apertures 12 respectively. The second materials 13 are thicker than the first material 11 that makes the skin layers 20 waved. In perspective view, the skin layers 20 have a plurality of convex portions because of the second materials 13. The multilayer foaming lamination of the second preferred embodiment may provide different visual or touching function when the foaming material 10 has different materials or foaming conditions.

As shown in FIG. 4, the third referred embodiment of the present invention provides a multilayer foaming lamination similar to the multilayer foaming lamination of the second preferred embodiment. The multilayer foaming lamination of the third referred embodiment has the second materials 13 thinner than the first material 11 that make the skin layers 20 having concave portions in perspective view. It is the same that multilayer foaming lamination of the third preferred embodiment may provide different visual or touching function when the foaming material 10 has different materials or foaming conditions.

What is claimed is:

1. A multilayer foaming lamination, comprising:
a foaming layer including a first material with apertures and second materials filled in the apertures respectively, wherein the first material and the second material are made of different materials; and
two skin layers provided on opposite sides of the foaming layer.

2. The multilayer foaming lamination as claimed in claim 1, wherein a thickness of the first material is the same as that of the second materials.

3. The multilayer foaming lamination as claimed in claim 1, wherein a thickness of the first material is greater than that of the second materials.

4. The multilayer foaming lamination as claimed in claim 1, wherein a thickness of the first material is less than that of the second materials.

5. The multilayer foaming lamination as claimed in claim 1, wherein the skin layers are made of cotton, flax, nylon or polymer weaved fabric, nonweaved fabric or gauze.

6. A multilayer foaming lamination, comprising:
a foaming layer including a first material with apertures and second materials filled in the apertures respectively wherein the first material and the second material are made of the same material but having different foaming conditions; and
two skin layers provided on opposite sides of the foaming layer.

7. The multilayer foaming lamination as claimed in claim 6, wherein a thickness of the first material is the same as that of the second materials.

8. The multilayer foaming lamination as claimed in claim 6, wherein a thickness of the first material is greater than that of the second materials.

9. The multilayer foaming lamination as claimed in claim 1, wherein a thickness of the first material is less than that of the second materials.

10. The multilayer foaming lamination as claimed in claim 6, wherein the skin layers are made of cotton, flax, nylon or polymer weaved fabric, nonweaved fabric or gauze.
